(19) United States
(12) Patent Application Publication
(10) Pub. No.: US 2024/0390114 A1
(43) Pub. Date: Nov. 28, 2024

(54) ORTHODONTIC DEVICE WITH ADJUSTABLE TIGHTNESS

(71) Applicant: Chien-Hung YU, Taichung (TW)

(72) Inventors: Chien-Hung YU, Taichung (TW); Chun-Yi HUANG, Changhua County (TW)

(21) Appl. No.: 18/324,451

(22) Filed: May 26, 2023

(51) Int. Cl. A61C 7/22; A61C 7/28

(52) U.S. Cl. CPC A61C 7/22; A61C 7/28; A61C 7/14

(57) ABSTRACT

An orthodontic device with adjustable tightness includes an orthodontic base and a buckling plate. The orthodontic base includes a fixing plate fixed on the tooth and a protrusion disposed on the fixing plate. The protrusion includes a groove provided for an archwire to pass through, and a side wall adjacent to the groove. The side wall includes a plurality of clamping grooves. The heights between each of the clamping grooves and a bottom wall of the grooves are different. The buckling plate includes a pressing section located above the archwire, and the pressing section is selectively inserted into one of the clamping grooves. A vertical distance between the pressing section and the bottom wall is between a first value and a second value, wherein the first value is smaller than a thickness of the archwire, and the second value is greater than a thickness of the archwire.

### FIELD OF THE INVENTION

The present invention relates to an orthodontic device, in particular to an orthodontic device with adjustable tightness.

### BACKGROUND OF THE INVENTION

Misaligned teeth are difficult to clean and unaesthetic. To align teeth, a dentist needs to perform orthodontics on teeth. The most common way used by dentists when performing orthodontics is to use an orthodontic bracket as disclosed in Taiwan patent No. TWI782296B, which provides a plurality of orthodontic brackets fixed to a plurality of teeth respectively, and each orthodontic bracket is towed by an elastically deformed archwire to apply a force to the teeth so as to drive the teeth to reach determined positions; and in response to all the teeth reaching the determined positions, the orthodontic treatment is completed.

An archwire and an orthodontic bracket are combined in two forms depending on orthodontic methods. In the first form as shown in FIG. 1, an archwire and an orthodontic bracket are slidable, so the orthodontic method is to tow an orthodontic bracket 2A to move under a tension 4 of an archwire 1A, which can make a tooth 3A move back and forth to correct the forward and backward misaligned teeth 3A.

In the second form as shown in FIG. 2, an archwire 1B and an orthodontic bracket 2B are fixed, so the orthodontic method is to tow the orthodontic bracket 2B to rotate through the archwire 1B, which can make the tooth to rotate 5 in situ to correct a skewed teeth 3B.

In order to combine the archwire with the orthodontic bracket to meet the orthodontic needs, the archwire is available in various wire diameters. In more detail, when the archwire is installed on the orthodontic bracket, a cover plate on the orthodontic bracket is used to cover the archwire to avoid accidental detachment of the archwire. When the archwire needs to slide relative to the orthodontic bracket, the wire diameter of the archwire will be selected to be smaller. The cover plate cannot squeeze the archwire with a relatively small wire diameter in the process of covering the cover plate, so the archwire can slide relative to the orthodontic bracket. When the archwire needs to be fixedly combined with the orthodontic bracket, the wire diameter of the archwire will be selected to be larger. The cover plate will squeeze the archwire with a relatively large wire diameter, so the archwire and the orthodontic bracket are fixedly combined together.

The above two orthodontic methods are usually used interactively, and it is known that the archwire needs to be replaced in the process of switching the orthodontic methods. The replacement of the archwire is time-consuming and labor-intensive, resulting in high orthodontic costs.

### SUMMARY OF THE INVENTION

The main objection of the invention is to provide an orthodontic device with adjustable tightness, which can meet the requirements that an archwire can slide relative to an orthodontic base or can be fixed on the orthodontic base without changing the archwire.

In order to achieve the above objection, the invention provides an orthodontic device with adjustable tightness, which is fixed to a tooth and provided for an archwire to pass therethrough. The orthodontic device includes an orthodontic base and a buckling plate. The orthodontic base comprises a fixing plate fixed on the tooth and a protrusion disposed on the fixing plate. The protrusion comprises a groove and a side wall, wherein the groove is provided for the archwire to pass therethrough transversely and to be disposed therein, and the side wall is adjacent to the groove, and the side wall comprises a plurality of clamping grooves, and wherein heights between each of the plurality of clamping grooves and a bottom wall of the groove are different.

The buckling plate is disposed below the groove of the protrusion, and the buckling plate flexibly bypasses a tail end of the protrusion and the groove, and extends toward the side wall. The buckling plate comprises a pressing section located above the archwire in the groove, wherein the buckling plate is selectively inserted into one of the plurality of clamping grooves, and a vertical distance between the pressing section and the bottom wall of the groove is between a first value and a second value, and wherein the first value is smaller than a thickness of the archwire, and the second value is greater than the thickness of the archwire. When the vertical distance is the first value, the pressing section presses against the archwire, and the archwire will be fixed on the orthodontic base and be unable to slide on the groove. When the vertical distance is the second value, the pressing section will not contact with the archwire in the groove, so the archwire and the pressing section are spaced from each other, and the archwire is capable of sliding on the groove without being pressed by the pressing section.

Accordingly, by selecting one of the plurality of clamping grooves to which the buckling plate is inserted, it can be selected to not press or press the archwire by the pressing section without replacing the archwire. When the pressing section does not press the archwire, the archwire can slide relative to the orthodontic base, and when the pressing section presses the archwire, the archwire is fixed to the orthodontic base. Therefore, the pressing section can be adjusted to contact to the archwire or not to meet the needs of tooth orthodontics.

### BRIEF DESCRIPTION OF THE DRAWINGS

FIG. 1 is a schematic diagram of a conventional orthodontic bracket used in a first form.

FIG. 2 is a schematic diagram of a conventional orthodontic bracket used in a second form.

FIG. 3 is a schematic structural diagram of the first embodiment of the invention.

FIG. 4 is a schematic diagram of a stereoscopic structure of a buckling plate of the first embodiment of the invention.

FIG. 5 is a first schematic diagram of a first embodiment of the invention.

FIG. 6 is a second schematic diagram of the first embodiment of the invention.

FIG. 7 is a schematic diagram of a second embodiment of the present invention.

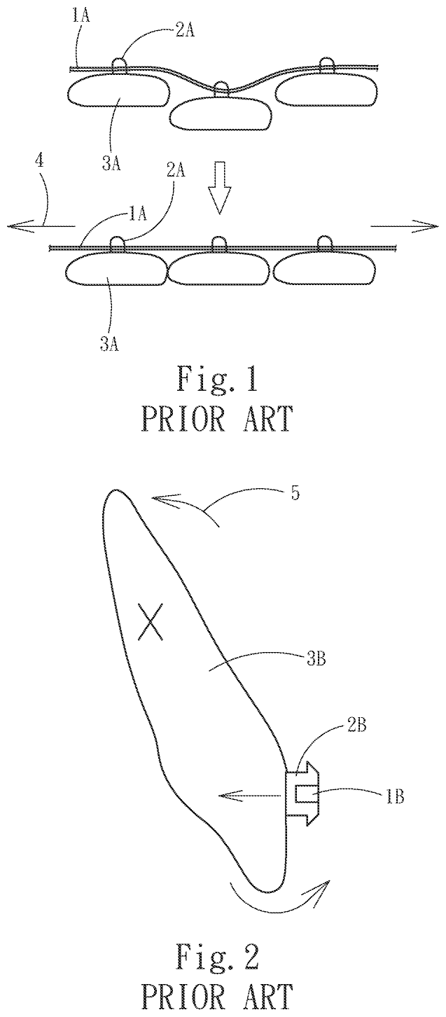

### DETAILED DESCRIPTION OF THE PREFERRED EMBODIMENTS

The detailed description and technical content of the invention are described below with reference to the accompanying drawings.

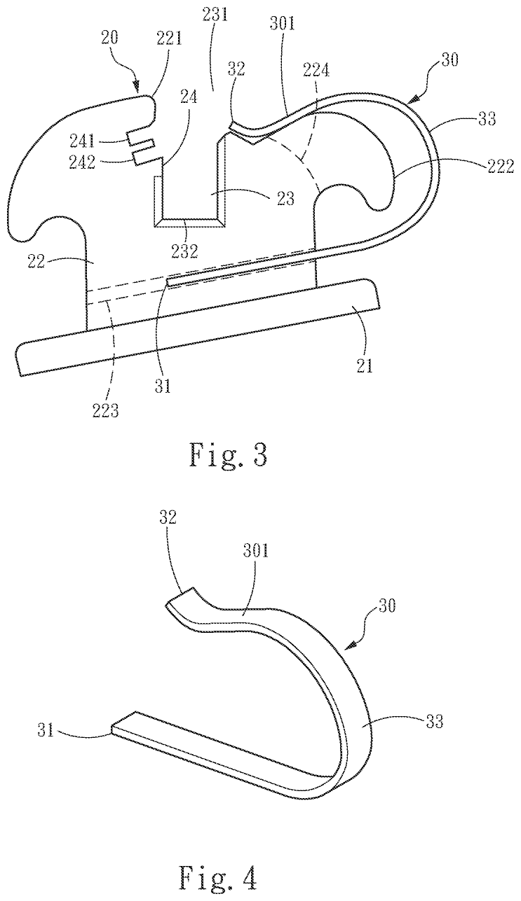

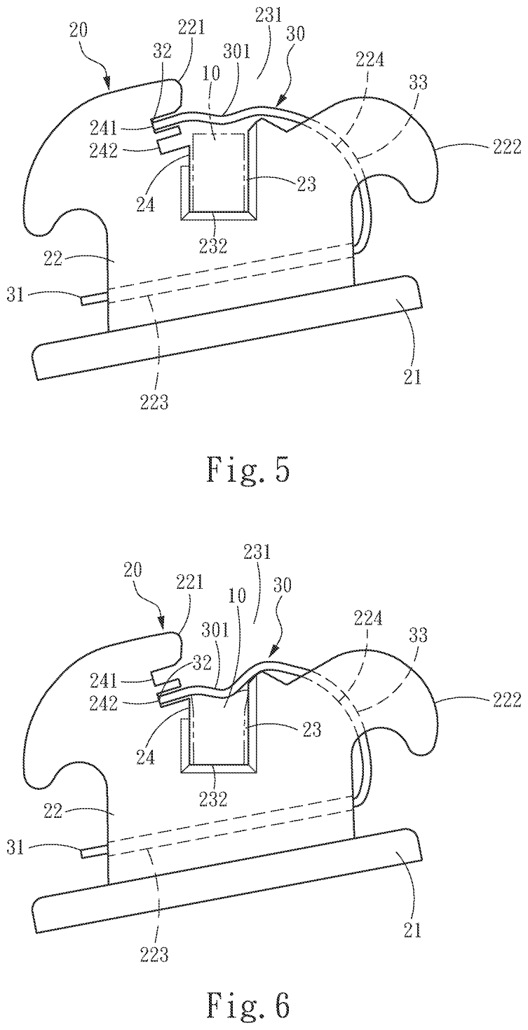

Please refer to FIG. 3, FIG. 4, FIG. 5, and FIG. 6 for a first embodiment of the invention. The invention is an orthodontic device provided for an archwire 10 to pass through and to be fixed on a tooth (not shown in the figures). The orthodontic device comprises an orthodontic base 20 and a buckling plate 30. The orthodontic base 20 includes a fixing plate 21 and a protrusion 22, wherein the fixing plate 21 is fixed on the tooth, the protrusion 22 is disposed on the fixing plate 21, the protrusion 22 includes a groove 23 and a side wall 24, and the groove 23 is provided for the archwire 10 to pass through transversely and to be disposed therein. In one embodiment, the groove 23 is formed by recessing downward from a top surface 221 of the protrusion 22, and the groove 23 includes an opening 231 for the archwire 10 to be inserted therein.

The side wall 24 is adjacent to the groove 23 and includes a plurality of clamping grooves, and heights between each of the plurality of clamping grooves and a bottom wall 232 of the grooves are different. In the first embodiment as shown in FIG. 3, FIG. 4, FIG. 5, and FIG. 6, a number of the clamping grooves is provided by using two, the reference numbers 241, 242, as an example.

The buckling plate 30 is disposed below the groove 23 of the protrusion 22, and the buckling plate 30 flexibly bypasses a tail end 222 of the protrusion 22 and the groove 23, and extends toward the side wall 24. The buckling plate 30 includes a pressing section 301, and the pressing section 301 is located above the archwire 10 in the groove 23. In one embodiment, the side wall 24 is located on a side of the groove 23 opposite to the tail end 222, and the clamping grooves 241, 242 are recessed obliquely and downwardly from the side wall 24 toward a direction opposite to the tail end 222. The clamping grooves 241, 242 are longitudinally spaced apart from each other. The buckling plate 30 further comprises a straight section 31, an operating section 32, and a curved section 33 located between the straight section 31 and the operating section 32. The straight section 31 is inserted into a fixing hole 223 of the protrusion 22, and the curved section 33 extends from the straight section 31 and bypasses the tail end 222 of the protrusion 22. The pressing section 301 is disposed at the operating section 32, and an end of the operating section 32 is selectively inserted into one of the clamping grooves 241 (or 242).

The end of the operating section 32 of the buckling plate 30 is selectively inserted into one of the clamping grooves 241 (or 242), and a vertical distance between the pressing section and the bottom wall is between a first value and a second value, wherein the first value is smaller than a thickness of the archwire 10, and the second value is greater than a thickness of the archwire 10.

Please refer to FIG. 5 for a schematic diagram showing that the vertical distance is greater than a thickness of the archwire 10. When the end of the operating section 32 of the buckling plate 30 is inserted into the clamping groove 241, the vertical distance between the pressing section 301 and the bottom wall 232 is the second value. The second value is greater than a thickness of the archwire 10, so the pressing section 301 of the buckling plate 30 does not contact with the archwire 10 in the groove 23. That is, the archwire 10 and the pressing section 301 are spaced apart from each other, so the archwire 10 is capable of sliding on the groove 23 without being pressed by the pressing section 301, and the archwire 10 is able to move relative to the orthodontic base 20.

Please refer to FIG. 6 for a schematic diagram showing that the vertical distance is smaller than a thickness of the archwire 10. When the end of the operating section 32 of the buckling plate 30 is inserted into the clamping groove 242, the vertical distance between the pressing section 301 and the bottom wall 232 is the first value, and the first value is smaller than a thickness of the archwire 10, so the pressing section 301 of the buckling plate 30 contacts and presses against the archwire 10 in the groove 23 to restrict the archwire 10 from sliding on the groove 23, that is, the archwire 10 will be fixed on the orthodontic base 20.

In the first embodiment, the fixing hole 223 penetrates through the protrusion 22, and the straight section 31 protrudes from the protrusion 22 after passing through the fixing hole 223, so a user only needs to press the straight section 31 protruding from the protrusion 22, the buckling plate 30 can be reversely moved, and the end of the operating section 32 of the buckling plate 30 can be separated from the clamping groove 241 or the clamping groove 242 to facilitate changing a position where the buckling plate 30 is inserted therein.

In order to prevent the buckling plate 30 from being dislocated or skewed, the curved section 33 of the buckling plate 30 abuts a limiting groove 224 of the tail end 222 of the protrusion 22. When the end of the operating section 32 of the buckling plate 30 is inserted into one of the clamping grooves 241 (or 242), the curved section 33 of the buckling plate 30 is located inside the limiting groove 224. In one embodiment, the end of the operating section 32 is curved, which forms a barb structure capable of preventing the end of the operating section 32 of the buckling plate 30 from accidentally detaching from the clamping groove 241 or the clamping groove 242.

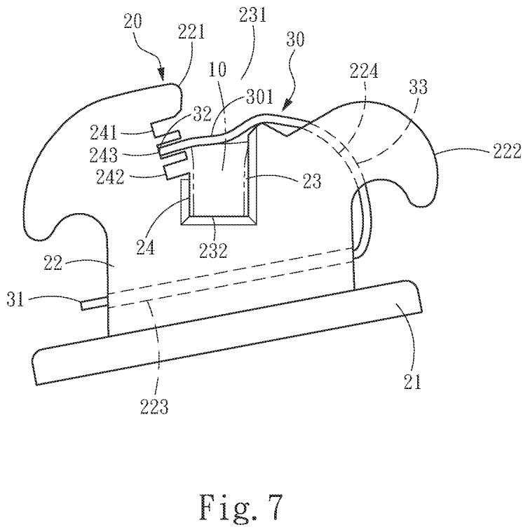

Please refer to FIG. 7 for a second embodiment of the invention. Compared with the first embodiment, a number of the clamping grooves of the second embodiment is provided by using three or more than three. In this embodiment, when the end of the operating section 32 of the buckling plate 30 is inserted into one of the clamping grooves 243, the vertical distance between the pressing section 301 and the bottom wall 232 is a third value between the first value and the second value, and the third value is equal to a thickness of the archwire 10. In the second embodiment as shown in FIG. 7, a number of the clamping grooves is provided by using three, the reference numbers 241, 242, 243, as an example.

When the end of the operating section 32 of the buckling plate 30 is inserted into the clamping groove 241, the vertical distance between the pressing section 301 and the bottom wall 232 is the second value, and the second value is greater than a thickness of the archwire 10, so the archwire 10 is capable of sliding on the groove 23. When the end of the operating section 32 of the buckling plate 30 is inserted into the clamping groove 242, the vertical distance between the pressing section 301 and the bottom wall 232 is the first value, and the first value is smaller than a thickness of the archwire 10, so the pressing section 301 presses against the archwire 10, and the archwire 10 will be fixed on the orthodontic base 20. When the end of the operating section 32 of the buckling plate 30 is inserted into the clamping groove 243 (as shown in FIG. 7), the vertical distance between the pressing section 301 and the bottom wall 232 is a third value, and the third value is equal to a thickness of the archwire 10. At this point, the archwire 10 can only slide on the groove 23 within a limited range due to a significant friction between the archwire 10 and the groove 23.

In the orthodontic therapy, the buckling plate 30 is inserted into the clamping groove 241 for a situation that the teeth need to have a large displacement; the buckling plate 30 is inserted into the clamping groove 243 for a situation that the teeth need to have a small displacement; and the buckling plate 30 is inserted into the clamping groove 242 for a situation that the teeth need to be rotated in situ.

In summary, the invention has at least the following characteristics:
1. The buckling plate can be selectively inserted into different clamping grooves, so the pressing section can be selected to press or not to press the archwire without changing the archwire, and therefore two ways of the combinations of the archwire and the orthodontic base are provided, where the archwire is capable of sliding relative to the orthodontic base; and the archwire is fixed on the orthodontic base, which can meet requirements of orthodontic use.
2. For the different orthodontic bases that the same archwire are passed therethrough, the pressing section on each orthodontic base can be independently selected whether pressing the archwire or not according to requirements, which can meet requirements of orthodontic use.
3. When the three clamping grooves or more than three clamping grooves are provided, the vertical distance between the pressing section and the bottom wall can be greater, smaller, or equal to a thickness of the archwire, which are respectively applicable to the situation where the teeth need to have a large displacement, the situation where the teeth need to be rotated in situ respectively, and the situation where the teeth need to have a small displacement.

What is claimed is:

1. An orthodontic device with adjustable tightness, being fixed to a tooth and provided for an archwire to pass therethrough, the orthodontic device comprising:
an orthodontic base, comprising a fixing plate fixed on the tooth and a protrusion disposed on the fixing plate, the protrusion comprising a groove and a side wall, wherein the groove is provided for the archwire to pass therethrough transversely and to be disposed therein, and the side wall is adjacent to the groove, and the side wall comprises a plurality of clamping grooves, and wherein heights between each of the plurality of clamping grooves and a bottom wall of the groove are different; and
a buckling plate, disposed below the groove of the protrusion, the buckling plate flexibly bypassing a tail end of the protrusion and the groove, and extending toward the side wall, the buckling plate comprising a pressing section located above the archwire in the groove, wherein the buckling plate is selectively inserted into one of the plurality of clamping grooves, and a vertical distance between the pressing section and the bottom wall of the groove is between a first value and a second value, and wherein the first value is smaller than a thickness of the archwire, and the second value is greater than the thickness of the archwire.

2. The orthodontic device with adjustable tightness according to claim 1, wherein the buckling plate further comprises a straight section, an operating section, and a curved section located between the straight section and the operating section, the straight section is inserted into a fixing hole of the protrusion, the curved section extends from the straight section and bypasses the tail end of the protrusion, the pressing section is disposed at the operating section, and an end of the operating section is selectively inserted into one of the plurality of clamping grooves.

3. The orthodontic device with adjustable tightness according to claim 2, wherein the fixing hole penetrates through the protrusion, and the straight section passes through the fixing hole and protrudes from the protrusion.

4. The orthodontic device with adjustable tightness according to claim 2, wherein the curved section abuts a limiting groove of the tail end of the protrusion.

5. The orthodontic device with adjustable tightness according to claim 2, wherein the end of the operating section is curved.

6. The orthodontic device with adjustable tightness according to claim 1, wherein the groove is formed by recessing downward from a top surface of the protrusion, and the groove includes an opening for the archwire to be inserted therein.

7. The orthodontic device with adjustable tightness according to claim 1, wherein the side wall is located on a side of the groove opposite to the tail end.

8. The orthodontic device with adjustable tightness according to claim 7, wherein the plurality of clamping grooves are recessed obliquely and downwardly from the side wall toward a direction opposite to the tail end.

9. The orthodontic device with adjustable tightness according to claim 1, wherein a number of the plurality of clamping grooves is at least three, and the vertical distance between the pressing section and the bottom wall of the groove is a third value between the first value and the second value, and the third value is equal to the thickness of the archwire.
